(19) United States
(12) Patent Application Publication
(10) Pub. No.: US 2018/0087895 A1
(43) Pub. Date: Mar. 29, 2018

(54) Composite Processing Machine for Detecting Material Height and Collision

(71) Applicant: Great Computer Corp., New Taipei City (TW)

(72) Inventors: Chien-Ping WONG, New Taipei City (TW); Chen-Chien TSAI, New Taipei City (TW); Hui-Te YU, New Taipei City (TW)

(21) Appl. No.: 15/277,243

(22) Filed: Sep. 27, 2016

(51) Int. Cl. G01B 11/06; G01B 17/00; G01B 5/06; G01N 21/59; G01B 11/30

(52) U.S. Cl. CPC G01B 11/0608; G01B 17/00; G01B 11/306; G01N 21/59; G01B 5/061

(57) ABSTRACT

A composite processing machine for detectiing material height and collision comprises a machine body, a contact detection unit, a non-contact detection unit, a control module, and a judgment module. The machine body is provided with an elevating working platform. An object to be processed is placed on the elevating working platform for laser processing operation. The contact detection unit and the non-contact detection unit are movably and displaceably disposed on the machine body. The control module is connected to the contact detection unit and the non-contact detection unit respectively. The judgment module determines the object's external property in order to drive the control module to control the contact detection unit and the non-contact detection unit respectively or sequentially to detect the object.

### BACKGROUND OF THE INVENTION

### Field of Invention

The present invention is related to a composite processing machine for detecting material height and collision so as to obtain the optimal detection result according to various characteristics of different objects to be processed on the same machine body, and is particularly suitable for X-Y axis platform processing machines such as laser engraving machines, laser cutting machines and platform printers.

### Description of the Related Art

The print-out industry nowadays mainly employs processing machines such as laser engraving/ cutting machines and inkjet printers. The basic principle of such processing machines is this: the output laser beam from a laser head on a carriage is guided and focused on the surface of an object to be engraved. After the focused beam is absorbed by the material, it increases the temperature abruptly, so as to have the surface of the object gasified and sunken; or the surface of the object is heated up and melted by the high-energy focused beam, and the melt part is blown off by high pressure gas, so as to achieve the purpose of engraving or cutting. Inkjet printers employ inkjet printheads to print different colors of ink on the same location from the ink cartridges, so as to present the desired color. It can achieve the quality like photos, save the time and work for making color separation for screen printing, so as to be more advantageous at this competitive era.

Generally, the above-mentioned processing machines employ a detection unit on an X-Y working platform for detecting the thickness of an object to be processed. In this case, it is not only able to prevent the object to be processed from being damaged by collision with a cutter, a laser head, or an inkjet printhead during the engraving, cutting, or ink-jet printing process, but it is also able to obtain the optimal distance between the object to be processed and the cutter, laser head, or inkjet printhead before the processing. However, each processing machine in the market is equipped with only one type of detection unit. Therefore, either contact detection or non-contact detection (e.g. optical detection) can be performed. Furthermore, the non-contact detection unit is easily affected by the environment, the properties and colors of the material, while the contact detection unit is easily affected by surface conditions of the object to be processed. For example, transparent acrylic materials can be detected only by using a contact detection unit. The non-contact detection unit is more suitable for an object to be processed with uneven thicknesses. Therefore, there is a need to put emphasis on how to obtain the optimal detection results according to different characteristics of various objects to be processed on the same machine body, so as to enhance the processing efficiency and increase the yield rate of finished products.

### SUMMARY OF THE INVENTION

A primary objective of the present invention is to provide a structurally simple and conveniently operatable composite processing machine for detecting material height and collision in order to obtain the optimal detection results according to different characteristics of various objects to be processed on the same machine body.

In order to achieve the above-mentioned objective, the present invention provides a composite processing machine for detecting material height and collision, which comprises a machine body, a contact detection unit, a non-contact detection unit, a control module, and an judgment module. An elevating working platform is disposed on the machine body. An object to be processed is placed on the elevating working platform for laser processing operation. The contact detection unit and the non-contact detection unit are movably and displaceably disposed on the machine body. The control module is connected to the contact detection unit and the non-contact detection unit respectively. The judgment module determines the object's external property, so as to drive the control module to control the contact detection unit and the non-contact detection unit respectively or sequentially to detect the object.

In implementation, the contact detection unit is a probe type or a limit-switch type contact detection unit.

In implementation, the non-contact detection unit is an infrared ray, laser, or ultrasound non-contact detection unit.

In implementation, the judgment module determines the object's external properties including transparency and surface evenness, so as to drive the control module to control the contact detection unit and the non-contact detection unit respectively or sequentially to detect the object.

In implementation, the contact detection unit and the non-contact detection unit move and displace on the machine body respectively by using a displacement unit disposed on the machine body. The displacement unit is a carriage, a carriage shaft, or an inkjet printhead.

The present invention will become more fully understood by reference to the following detailed description thereof when read in conjunction with the attached drawings.

### BRIEF DESCRIPTION OF THE DRAWINGS

FIG. 1 is a perspective view of a contact detection unit disposed on a machine body according to an embodiment of the present invention;

FIG. 2 is a perspective view of a non-contact detection unit disposed on the machine body according to the embodiment of the present invention.

FIG. 3 is a framework diagram according to the embodiment of the present invention.

### DETAILED DESCRIPTION OF THE INVENTION

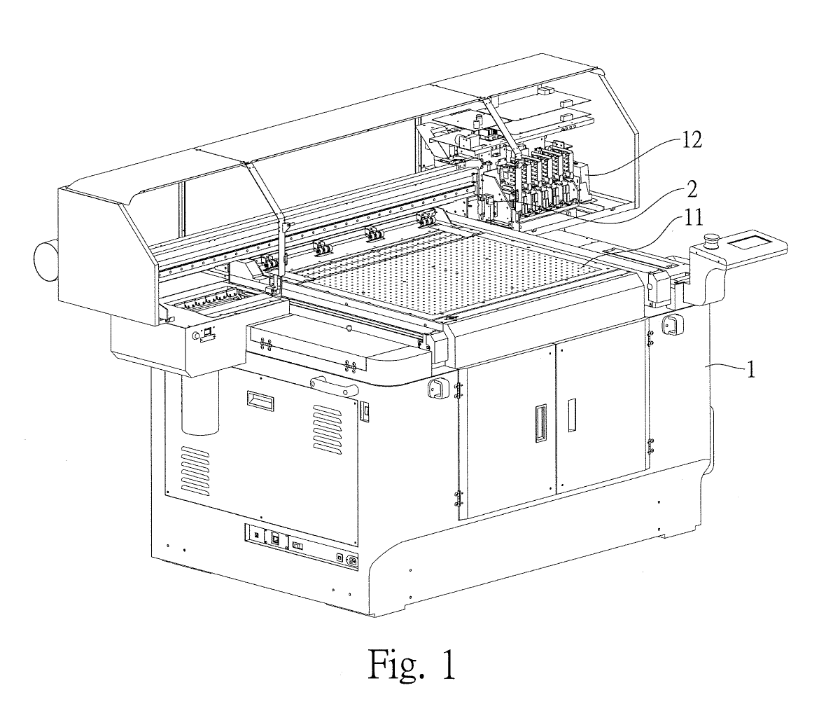

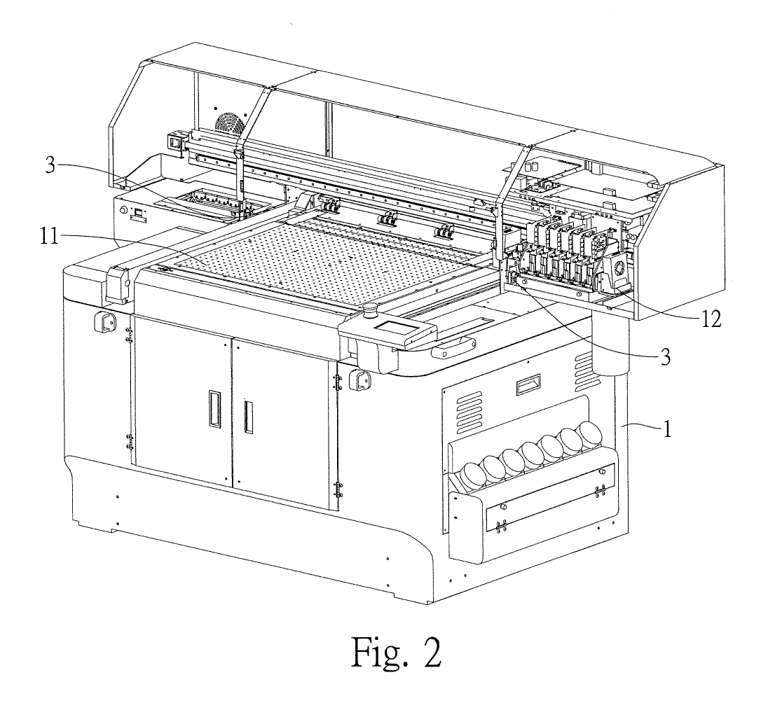

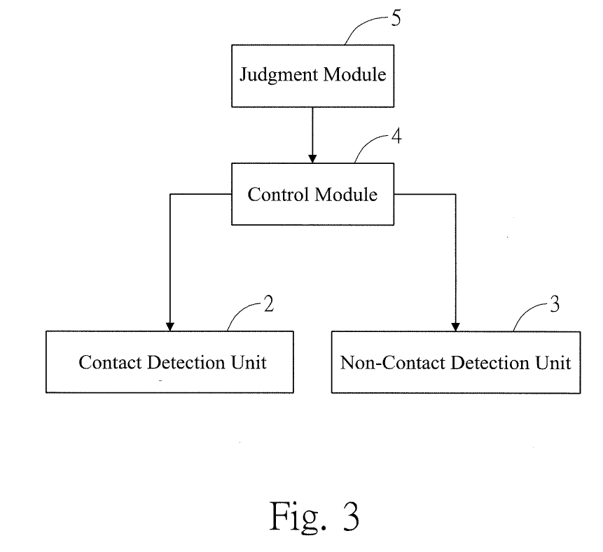

Please refer to FIGS. 1 to 3, which show a composite processing machine for detecting material height and collision according to an embodiment of the present invention. The composite processing machine for detecting material height and collision comprises a machine body 1, a contact detection unit 2, a non-contact detection unit 3, a control module 4, and an judgment module 5.

The height position of an elevating working platform 11 disposed on the machine body 1 can be adjusted. A plurality of displacement units 12 (movable units such as carriage, carriage shaft or inkjet printhead) is disposed on the elevating working platform 11 of the machine body 1. The contact detection unit 2 and the non-contact detection unit 3 are respectively disposed on different displacement units 12 of the machine body 1. The contact detection unit 2 is a probe type or a limit-switch type contact detection unit. The non-contact detection unit 3 is an infrared ray, laser, or ultrasound non-contact detection unit. Therefore, the object to be processed placed on the elevating working platform 11 can be processed with laser processing operation.

The control module 4 is connected to the contact detection unit 2 and the non-contact detection unit 3 respectively for controlling the contact detection unit 2 and the non-contact detection unit 3 to detect the object to be processed.

The judgment module 5 determines the external properties of the object to be processed, such as transparency and surface evenness, and accordingly drives the control module 4 to control the contact detection unit 2 and the non-contact detection unit 3 respectively or sequentially to detect the object to be processed.

Therefore, in implementation, when an object to be processed is placed by an user on the elevating working platform 11, the judgment module 5 is activated to determine the object. For example, if the object to be processed is a transparent material, the control module 4 is driven to control the contact detection unit 2 to detect the thickness of the object. If the object to be processed is a non-transparent material, the control module 4 is driven to control the contact detection unit 2 or the non-contact detection unit 3 to detect the thickness of the object. If the object to be processed is a non-transparent material and has uneven surface heights, the control module 4 is driven to control the non-contact detection unit 3 to precisely detect the thicknesses of the object. Thereby, it can prevent the object to be processed from being damaged by the collision with a cutter, a laser head, or an inkjet printhead during the subsequent engraving, cutting, or ink jetting process. Moreover, it is also able to obtain the optimal distance between the surface of the object to be processed and the cutter, laser head, or inkjet printhead and before the processing operation begins.

According to the above disclosure, the expected objective can be achieved by providing the composite processing machine for detecting material height and collision of the present invention.

Although the embodiments of the present invention have been described in detail, many modifications and variations may be made by those skilled in the art from the teachings disclosed hereinabove. Therefore, it should be understood that any modification and variation equivalent to the spirit of the present invention be regarded to fall into the scope defined by the appended claims.

What is claimed is:

1. A composite processing machine for detecting material height and collision, comprising:
a machine body, provided with an elevating working platform with an adjustable height position, where an object to be processed is placed on the elevating working platform for laser processing operation;
a contact detection unit, movably and displaceably disposed on the machine body;
a non-contact detection unit, movably and displaceably disposed on the machine body;
a control module, connected to the contact detection unit and the non-contact detection unit respectively for controlling the contact detection unit and the non-contact detection unit to detect the object; and
a judgment module, for determining the object's external property in order to drive the control module to control the contact detection unit and the non-contact detection unit respectively or sequentially to detect the object.

2. The composite processing machine for detecting material height and collision as claimed in claim 1, wherein the contact detection unit is a probe type or a limit-switch type contact detection unit.

3. The composite processing machine for detecting material height and collision as claimed in claim 1, wherein the non-contact detection unit is an infrared ray, laser, or ultrasound non-contact detection unit.

4. The composite processing machine for detecting material height and collision as claimed in claim 1, wherein the judgment module determines the object's external properties including transparency and surface evenness, so as to drive the control module to control the contact detection unit and the non-contact detection unit respectively or sequentially to detect the object.

5. The composite processing machine for detecting material height and collision as claimed in claim 1, wherein the contact detection unit and the non-contact detection unit are moved and displaced on the machine body respectively by using a displacement unit disposed on the machine body.

6. The composite processing machine for detecting material height and collision as claimed in claim 5, wherein the displacement unit is a carriage or a carriage shaft.
